(19) United States
(12) Patent Application Publication
(10) Pub. No.: US 2022/0221838 A1
(43) Pub. Date: Jul. 14, 2022

(54) PROCESS FOR PRODUCING INDIVIDUALIZED ARTIFICIAL NIPPLE

(71) Applicant: Brandon Heeger, Avon, IN (US)

(72) Inventor: Brandon Heeger, Avon, IN (US)

(21) Appl. No.: 17/544,557

(22) Filed: Dec. 7, 2021

Related U.S. Application Data
(60) Provisional application No. 63/122,014, filed on Dec. 7, 2020.

(51) Int. Cl. G05B 19/4099; A61J 17/00

(52) U.S. Cl. CPC G05B 19/4099; A61J 17/001; G05B 2219/49023; G05B 2219/35012; A61J 17/10

(57) ABSTRACT

The present disclosure is directed to an individualized artificial nipple made by a process comprising the steps of capturing surface geometry of a mammalian nipple with a device configured for capturing depth data, transferring the depth data to an additive manufacturing device, using the depth data to create a file format used for additive manufacturing, and producing a replica of the mammalian nipple using additive manufacturing.

### CROSS-REFERENCE TO RELATED APPLICATIONS

The present application claims the benefit of US Provisional Patent Application 63/122,014 filed Dec. 7, 2020, under 35 USC § 119(e).

### BACKGROUND

There are numerous commercially available pacifiers and bottle nipples. Pacifiers, traditionally, are mimics of female nipples used to soothe a child. The importance of these items being effective is common knowledge; however, the benefit of highly effective, or structurally similar, pacifiers and bottle nipples can be more nuanced. Some of the more nuanced items might be reduction in Sudden Infant Death Syndrome (SIDS) and reduction in nipple confusion. Current medical literature suggests pacifiers reduce rates of SIDS. Unfortunately, not all babies will utilize a pacifier, or their adherence is not optimal. Nipple confusion is also a frequently debated, but can occur when introducing a pacifier, or when switching between breast and bottle feeding. Despite this knowledge, the commercially available variety of pacifiers and bottle nipples fail to replicate the exact shape, size, texture, and contour of mammalian anatomy. In addition, they are not individualized to replicate a specific female's anatomy (nipple, areola, or combination of nipple and areola). Some research suggests using various methods to create a more individualized pacifier or bottle nipple, such as using a mold or combining multiple images at different angles; however, none of these methods were found to be commercially available, and, regardless, would fail to create a highly precise replication of the desired human anatomy. In addition, the processes described were cumbersome, not readily available, and often required the assistance of an additional person(s) exposing sensitive anatomy.

### SUMMARY

The present disclosure is directed to an individualized artificial nipple made by a process comprising the steps of capturing surface geometry of a mammalian nipple with a device configured for capturing depth data, transferring the depth data to an additive manufacturing device, using the depth data to create a file format used for additive manufacturing, and producing a replica of the mammalian nipple using additive manufacturing.

### BRIEF DESCRIPTION OF THE DRAWINGS

FIG. 1 depicts a diagrammatic view of components of an exemplary process, according to the present disclosure.

FIG. 2 depicts a flow diagram of the exemplary process of the present disclosure.

### DETAILED DESCRIPTION

Before the present methods, implementations, and systems are disclosed and described, it is to be understood that this invention is not limited to specific implementations, and as such may, of course, vary. It is also to be understood that the terminology used herein is for the purpose of describing particular implementations only and is not intended to be limiting.

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

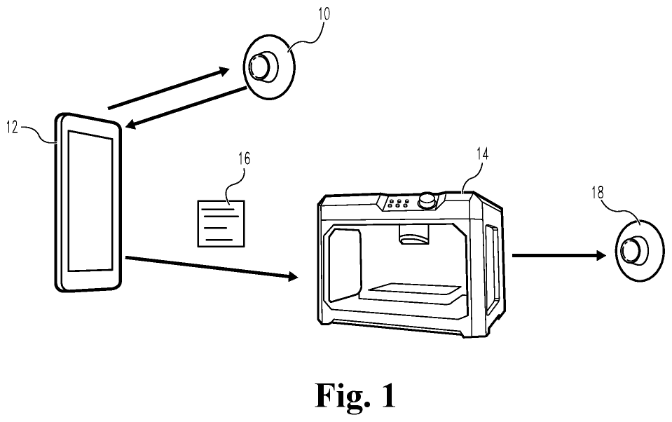

Referring to FIG. 1, a process of producing an individualized artificial nipple is shown. A mammalian nipple is shown at 10 in FIG. 1. A device 12 for capturing depth data is used for capturing surface geometry of the mammalian nipple 10. This surface geometry is, exported, or transferred, to an additive manufacturing device 14. During the process, the surface geometry and/or depth data is used to create a file format 16 used for additive manufacturing. This file format 16 is ultimately used to produce an individualized replica of 18 or mold for the mammalian nipple using the additive manufacturing device 14.

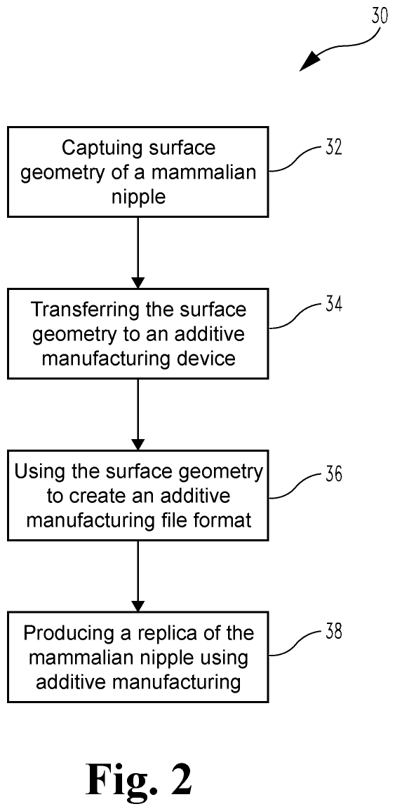

This process is described in more detail in FIG. 2, but continued reference to FIG. 1 is also made. In FIG. 2, a process 30 for producing an individualized artificial nipple, or replica, 18 is illustrated. At a first step, at 32, surface geometry of a mammalian nipple 10 is captured. This may be accomplished using light emitted from a device, such as, for example, TrueDepth (or similar dot projection) or Lidar, to obtain precise data of the desired mammalian anatomy. The utilized device 12, for example, may be a handheld device. Using a handheld device, such as a smartphone, the required data may be readily available, efficient, and may eliminate unnecessary exposure of sensitive anatomy.

The data capture and export may both be accomplished using the same device, such as a mobile device, as described above. This data, including surface geometry, is ultimately transferred to an additive manufacturing device 14, at 34. At some point in the process, the surface geometry is used to create an additive manufacturing file format 16, at 36. At 38, a replica (18) or mold for the mammalian nipple 10 is produced using additive manufacturing.

Materials for producing the individualized artificial nipple may include FDA approved materials, including, for example, an elastomer material.

This process will result in a precise, individualized pacifier or mold therefor made using 3-dimensional printing, which will result in a precise, individualized pacifier or bottle nipple. That is, the current process may be used to make an individual artificial nipple that replicates the size, texture and firmness of a mother's natural nipple.

I/We claim:

1. An individualized artificial nipple made by a process comprising the steps of:
capturing surface geometry of a mammalian nipple with a device configured for capturing depth data;
transferring the surface geometry to an additive manufacturing device;
using the surface geometry to create a file format used for additive manufacturing; and
producing a replica of or mold for the mammalian nipple using additive manufacturing.

2. The process of claim 1, wherein the device configured for capturing depth data is a handheld device.

3. The process of claim 2, wherein the handheld device is a smartphone.

4. The process of claim 1, wherein the individualized artificial nipple is used with a pacifier.

5. The process of claim 1, wherein the individualized artificial nipple is used with a baby bottle.

6. The process of claim 1, wherein the individualized artificial nipple is made from an elastomer material.
